(19) United States
(12) Patent Application Publication
(10) Pub. No.: US 2007/0097549 A1
(43) Pub. Date: May 3, 2007

(54) MAGNETIC HEAD ASSEMBLY HAVING AuSn DISPERSION LAYER AND METHOD OF SOLDER BONDING

(75) Inventors: Ooki Yamaguchi, Niigata-ken (JP); Takao Haino, Niigata-ken (JP); Hideaki Abe, Niigata-ken (JP); Toshihiko Sato, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD, Tokyo (JP)

(21) Appl. No.: 11/553,884

(22) Filed: Oct. 27, 2006

(30) Foreign Application Priority Data
Nov. 1, 2005 (JP) 2005-318708

(51) Int. Cl. G11B 5/10

(52) U.S. Cl. 360/129; 360/313

(57) ABSTRACT

A magnetic head assembly is provided. The magnetic head assembly has electrode pads of a slider that have a magnetoresistive element installed therein and electrode pads of a flexible printed circuit that connect the magnetoresistive element to an external circuit are bonded by solder. In one embodiment, an Au layer is formed on solder contact surfaces of the electrode pads of the slider and the flexible printed circuit, and an AuSn dispersion layer where Au atoms of the Au layer are dispersed is formed at least on the boundary between the solder contact surfaces of the electrode pads and the solder.

This patent document claims the benefit of Japanese Patent Application No. 2005-318708 filed on Nov. 1, 2005, which is hereby incorporated by reference.

### BACKGROUND

1. Field

The present embodiments relate to a magnetic head assembly having AuSn dispersion layer and method of solder bonding.

2. Related Art

Generally, a magnetic head assembly, which is used in a hard disc drive (HDD), includes a slider that has a magnetoresistive element installed therein, a flexure that is formed of a thin flexible sheet metal so as to elastically support the slider, and a flexible printed circuit that is attached to the surface of the flexure and electrically connects the magnetoresistive element of the slider and a circuit system of a device on which the magnetic head assembly is mounted. The flexure is fixed to a load beam by, for example, spot welding. In general, in this type of magnetic head assembly, electrode pads for the magnetoresistive element of the slider and electrode pads of the flexible printed circuit are bonded to each other by a gold ball bonding method according to orthogonal positional relationships between the electrode pads. Recently, in order to cope with reduction in a bonding area (sizes of the electrode pads and intervals between the electrode pads), a solder ball bonding method using a solder ball, which has a smaller spherical diameter than the gold ball, has been proposed (for example, see JP-A-2004-283911 (US 2004228036A1)).

The solder ball bonding method can be performed by using, for example, a mounter of an SJB method that sprays a molten solder ball on a joint surface. As the molten solder supplied from the mounter onto the joint surface is solidified, the electrode pads of the slider and the electrode pads of the flexible printed circuit are bonded to each other. A surface protective layer, which is made of Au, is formed on the surfaces (joint surfaces) between the electrode pads of the slider and the flexible printed circuit so as to increase solder wettability.

As described above, when the solder ball in a melted state is supplied, the solder ball rapidly cools as soon as the solder ball is supplied to the joint surface, and Au is solidified before being sufficiently diffused into the solder. For this reason, an Au—Sn compound layer is formed at the boundary between the solidified solder and the electrode pads, and peeling of solder junctions is generated due to the Au—Sn compound layer. In addition, posture of the slider (pitch angle) greatly changes after the solder bonding because of shrinkage distortion that is generated when the solder ball is solidified. This change in posture reduces (worsens) a floating characteristic of the magnetic head slider, for example, an output characteristic.

### SUMMARY

The present embodiments may obviate one or more of the limitations of the related art. For example, in one embodiment, a magnetic head assembly and a solder bonding method thereof are capable of increasing bond reliability and preventing a change in posture of a slider.

The present embodiments have been finalized in view of the fact that under the recognition that an Au—Sn compound layer formed along the boundary between solidified solder and electrode pads causes peeling, the Au—Sn compound layer formed on the solder joint surface of the electrode pads can be dispersed into the molten solder by supplying a solder ball in a melted state to the joint surface and applying sufficient heat energy to the joint surface, and bending of a slider can be reduced by relieving shrinkage distortion of the solidified solder.

In one embodiment, a magnetic head assembly has electrode pads of a slider that have a magnetoresistive element installed therein. Electrode pads of a flexible printed circuit connect the magnetoresistive element to an external circuit and are bonded by solder. An Au layer is formed on solder contact surfaces of the electrode pads of the slider and the flexible printed circuit. An AuSn dispersion layer where Au atoms of the Au layer are dispersed is formed at least on the boundary between the solder contact surfaces of the electrode pads and the solder.

In one embodiment, the AuSn dispersion layer is equal to or greater than 50 μm in thickness. Since an adhesive layer (a NiSn or CuSn compound) is formed between the electrode pads and the solder, it is possible to increase solder bond strength.

In one embodiment, the AuSn dispersion layer has a higher Au atomic content toward the electrode pads from the solder.

An Sn compound layer made of materials of the electrode pads and Sn may be interposed between the electrode pads and the AuSn dispersion layer. The electrode pad may be formed of a single layer structure of Ni or Cu, or a laminated structure of Ni and Cu.

In one embodiment, a solder bonding method of a magnetic head assembly that bonds electrode pads of a slider has a magnetoresistive element installed therein and electrode pads of a flexible printed circuit that connect the magnetoresistive element and an external circuit by solder. The method includes preparing a capillary that has a carrier path that carries a solder ball by an inert gas stream and melts the solder ball by a laser beam that passes through the carrier path, disposing the capillary on bonding surfaces between the electrode pads of the slider and the electrode pads of the flexible printed circuit, introducing the solder ball and an inert gas stream into the carrier path of the capillary and causing the solder ball to drop on the bonding surfaces of the electrode pads with the solder ball melted by the laser beam that passes through the same carrier path, waiting until the solder ball dropped is solidified, and remelting the solidified solder ball by laser beam irradiation to resolidify the remelted solder ball and bonding the electrode pads of the slider to the electrode pads of the flexible printed circuit.

For the second laser irradiation, a laser beam in the same axial direction as the capillary that passes through the carrier path of the capillary may be used, or a laser beam in an axial direction different from the capillary that is irradiated outside of the capillary may be used. For example, the laser irradiation onto the solidified solder ball may be performed by approaching the capillary to the solder ball and remelting the solder ball by the laser beam that passes through the carrier path of the capillary. Also, the laser irradiation onto the solder ball may be performed by remelting the solder ball by the laser beam irradiated from the direction different from the capillary.

In one embodiment of the solder bonding method, the laser beam is irradiated by using a semiconductor laser, an ultraviolet laser, or a YAG laser.

### BRIEF DESCRIPTION OF THE DRAWINGS

FIG. 1 is a schematic diagram that illustrates the construction of a magnetic head assembly (finished state) according to one embodiment;

FIG. 2 is an enlarged schematic diagram that illustrates a joint portion of electrode pads of a slider and electrode pads of a flexible printed circuit that are shown in FIG. 1;

FIG. 3 is an enlarged sectional view that illustrates a solder fillet in FIG. 2;

FIG. 4 is a schematic plan view that illustrates a capillary that is used for a solder bonding method according to one embodiment;

FIG. 5 is a schematic plan view that illustrates a process of the solder bonding method according to one embodiment;

FIG. 6 is a schematic sectional diagram that illustrates a process next to the process in FIG. 5;

FIG. 7 is a schematic sectional diagram that illustrates a process next to the process in FIG. 6;

FIG. 8A is a schematic sectional diagram that illustrates posture of a slider after first laser irradiation;

FIG. 8B is a schematic sectional diagram that illustrates posture of a slider after second laser irradiation;

FIG. 9A is a scatter diagram that shows a change in posture of a slider before and after solder bonding by one laser irradiation;

FIG. 9B is a scatter diagram that shows a change in posture of a slider before and after solder bonding by two laser irradiations;

FIG. 10 is a schematic plan view that illustrates a capillary that is used for a solder bonding method according to another embodiment;

FIG. 11 is a cross-sectional view that illustrates a delivery end portion of a capillary in FIG. 10 by partially fracturing the delivery end portion;

FIG. 12 is a side surface diagram that illustrates the delivery end portion of the capillary in FIG. 10;

FIG. 13 is a plan view that illustrates the delivery end portion of the capillary in FIG. 12;

FIG. 14 is a schematic sectional view that illustrates a process of a solder bonding method according to another embodiment;

FIG. 15 is a schematic sectional view that illustrates a process next to the process in FIG. 14;

FIG. 16 is a schematic sectional view that illustrates a process next to the process in FIG. 15;

FIG. 17 is a schematic sectional view that illustrates a process next to the process in FIG. 16; and

FIG. 18 is a schematic sectional view that illustrates a process next to the process in FIG. 17.

### DETAILED DESCRIPTION

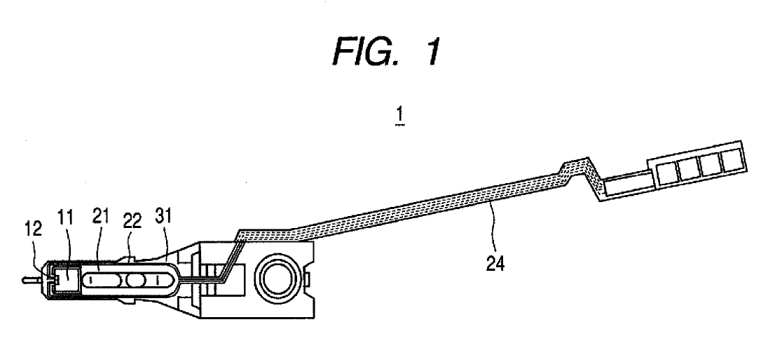

FIG. 1 is a diagram that illustrates a magnetic head assembly (a finished state) for a hard disc drive according to one embodiment. A magnetic head assembly 1 includes a slider 11 that has a magnetoresistive element 12 (a magnetic head) installed therein, and a flexure 21 bonded to a rear surface of the slider 11 with, for example, a thermosetting adhesive, a UV curable adhesive, a conductive adhesive, or the like.

The flexure 21 is a thin flexible sheet metal that has a plate spring shape. The flexure 21 is mounted on a front end of a load beam in a state where the flexure 21 floatingly supports the slider 11 elastically relative to the load beam. A flexible printed circuit (FPC) 22 is fixed to the surface of the flexure 21 by adhesion that uses an adhesive. The flexible printed circuit 22 electrically connects the magnetoresistive element of the slider 11 to a circuit system of a hard disc device on which the magnetic head assembly is mounted.

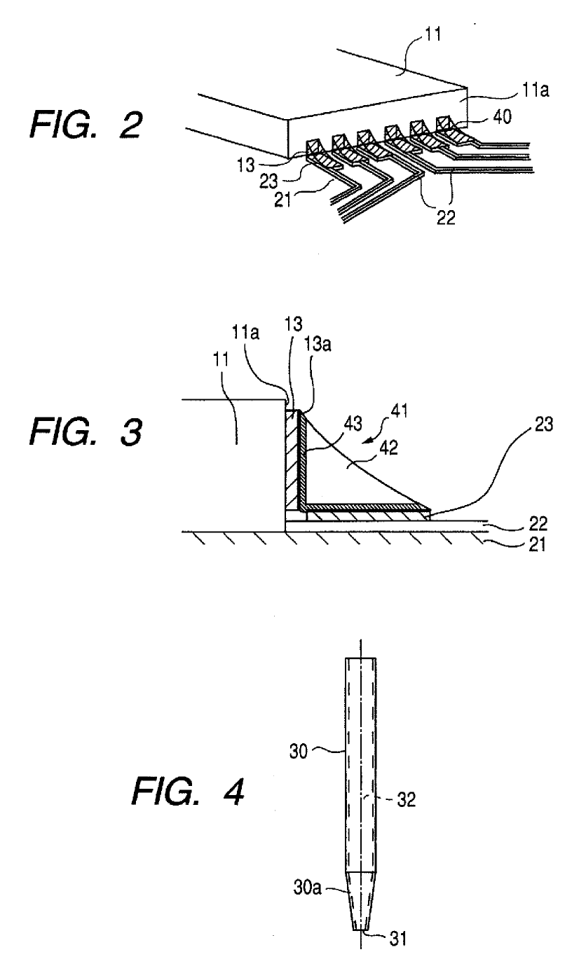

As shown in FIG. 2, the flexible printed circuits 22 are divided into two edge portions from a plurality of electrode pads 23 disposed at front ends of the flexures 21 and are further extended from both edge portions. The flexible printed circuits 22 are further extracted from edge portions of rear ends of the flexures 21, and collected as one flexible printed circuit through a relay flexible printed circuit 24. The relay flexible printed circuit 24 is connected to the circuit system of the hard disc device on which the magnetic head assembly 1 is mounted. The slider 11 has a plurality of electrode pads 13 that are connected to the magnetoresistive element 12 in a slider section 11a. The electrode pads 13 and the electrode pads 23 of the flexible printed circuit 22 are mounted on the flexure 21 in a perpendicular position in relation to each other.

In one embodiment of the magnetic head assembly 1 the electrode pads 13 of the slider 11 and the electrode pads 23 of the flexible printed circuit 22, which are provided according to orthogonal positional relationships, are solder-ball bonded using tin-based Sn solder that does not contain lead.

As shown in FIG. 3, a solder fillet 41 (a solder joint) bonds the electrode pads 13 of the slider 11 and the electrode pads 23 of the flexible printed circuit 22. Au plating layers 13a and 23a are formed on surfaces (solder contact layers) of the electrode pads 13 of the slider 11 and the electrode pads 23 of the flexible printed circuit 22 so as to improve solder wettability.

In one embodiment, even though most of the solder fillet 41 is formed of solidified Sn solder 42, an AuSn dispersion layer 43 exists at least along the boundary of the electrode pads 13 and 23 and the Sn solder 42. The AuSn dispersion layer 43 is generated as follows. An AuSn compound is formed on the surfaces of the electrode pads 13 and 23, when the Sn solder 42 is melted and solidified for the first time. When the Sn solder 42 is melted for the second time, the AuSn compound is dispersed into the Sn solder 42. The Sn solder 42 is solidified again in a state where the AuSn compound is dispersed into the Sn solder 42. An Au atomic concentration of the AuSn dispersion layer 43 at the electrode pads 13 and 23 is higher than that at the Sn solder 42. The Au plating layers 13a and 23a are in a range of about 0.5 to 2.6 μm in thickness. The AuSn dispersion layer 43 has the thickness equal to or more than about 50 μm.

Referring to FIGS. 4 to 8, a solder bonding method according to a first embodiment will be described.

As shown in FIG. 4, a capillary 30 is prepared. The capillary 30 is a single-capillary that bonds spherical solder balls 40 one by one. The capillary 30 has an elongated cylindrical shape and includes a delivery end portion 30a whose tip is narrow.

The capillary 30 includes a circular delivery hole 31 that is formed at the center of a front end surface of the delivery end portion 30a so as to deliver the spherical solder ball 40. A carrier path 32 that extends along an axial direction of the capillary 30 carries the spherical solder ball 40 and a nitrogen gas stream N₂ to the circular delivery hole 31. The capillary 30 is connected to a laser heat source. A YAG laser is used as the laser heat source. The laser beam outputted from the laser heat source has the center of the light beam in parallel with the axial direction of the capillary 30.

The laser beam passes through the carrier path 32 and then it is emitted from the delivery hole 31 to the outside. The laser beam is irradiated onto the solder ball 40 when the solder ball 40 is carried along the carrier path 32 by the nitrogen gas stream N₂.

The solder ball 40 in the melted state is discharged from the delivery hole 31 to the outside. Though not shown, the capillary 30 includes an introduction hole through which the spherical solder ball 40 and the nitrogen gas stream N₂ are inserted into the carrier path 32. In the present embodiment, the solder ball 40 is not more than about φ100 μm in diameter, and an effective spot diameter of the laser beam used is about φ100 μm.

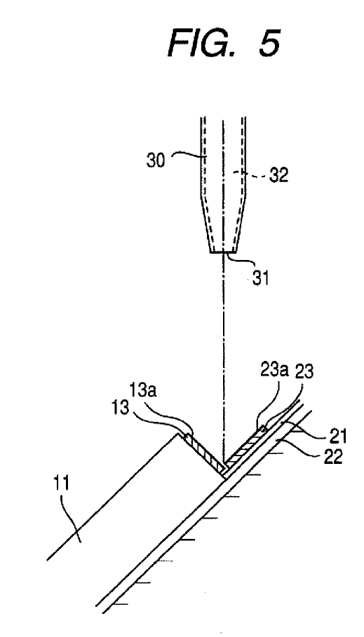

As shown in FIG. 5, the slider 11 and the flexible printed circuit 22 are provided on a mount with the electrode pads 13 and 23 thereof meeting each other at about 90 degrees. The mount is fixed and tilted 45 degrees counterclockwise from a horizontal direction (a right and left direction in FIG. 5). The capillary 30 is tilted about 45 degrees from both of the electrode pads 13 of the slider 11 and the electrode pads 23 of the flexible printed circuit 22, for example, the capillary 30 is provided along a vertical direction (an up and down direction in FIG. 5). The delivery end portion 30a of the capillary 30 is spaced by about 50 μm from a joint surface of the electrode pads 13 of the slider 11 and the electrode pads 23 of the flexible printed circuit 22.

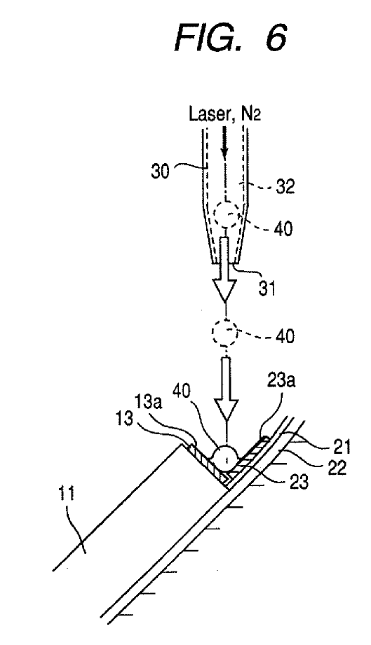

As shown in FIG. 6, the solder ball 40 and the nitrogen gas stream N₂ are introduced into the carrier path 32 of the capillary 30, and the laser heat source is operated to output a laser beam to the carrier path 32. The solder ball 40 is formed of tin-based solder that does not include lead, and is not more than about Ø100 μm in diameter. The solder ball 40 inserted into the carrier path 32 is melted by the laser beam that proceeds in parallel with the axial direction of the capillary 30. The molten solder ball 40 is sent to the delivery hole 31 by the nitrogen gas stream N₂ that flows through the same carrier path. The molten solder ball 40 free falls between the electrode pads 13 of the slider 11 and the electrode pads 23 of the flexible printed circuit 22 from the delivery hole 31. As soon as the solder ball 40 rapidly cools down by the electrode pads 13 and 23, which are a falling point, for example, before Au is sufficiently dispersed into the solder, the solder ball 40 is solidified. Since the Au plating layers 13a and 23a are formed on the surfaces of the electrode pads 13 and 23, an AuSn compound layer is formed along the boundary of the electrode pads 13 and 23 and the Sn solder 42.

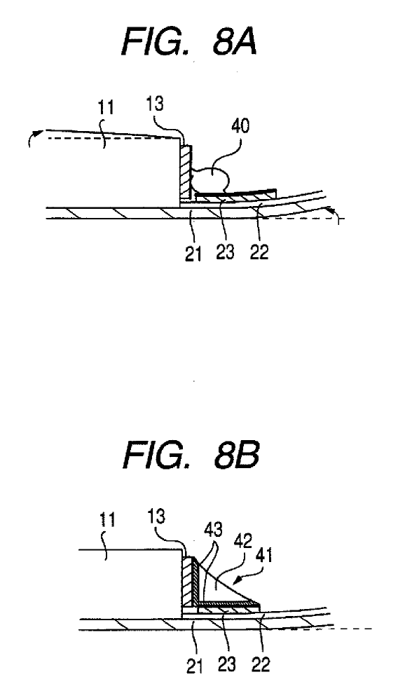

As shown in FIG. 8A, since the flexure 21 is subjected to shrinkage distortion by the solidification of the solder ball 40, the flexure 21 is bent counterclockwise from the horizontal direction. Oxidization of the solidified solder ball 40 is prevented by the nitrogen gas stream N₂. By the above-described process, the first melting and solidification are performed.

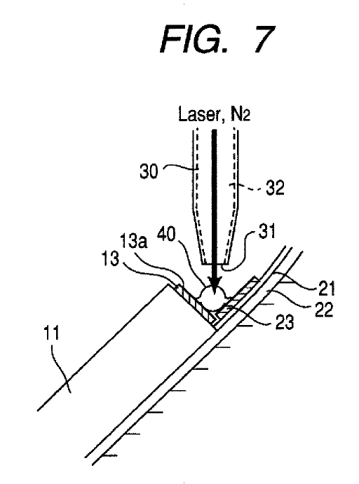

As shown in FIG. 7, as the capillary 30 approaches the solidified solder ball 40, the laser beam is irradiated onto the solder ball 40 at a close distance. Laser irradiating time is set long enough to completely melt the solder ball 40, for example, the laser irradiating time is equal to and more than about 10 ms. A laser beam that is irradiated in a different direction from the capillary 30 may be used for the laser irradiation.

When the solder ball 40 is completely melted, the AuSn compound layer formed on the surfaces of the electrode pads 13 and 23 is dispersed into the molten solder. The molten solder, which includes the dispersed Au atoms, is solidified, thereby forming the solder fillet 41 (See FIG. 3). In the solder fillet 41 that is formed by this second melting and solidification, the AuSn dispersion layer 43 is generated at least along the boundary between the electrode pads 13 and 23 and the solidified Sn solder 42. The Au atomic concentration of the AuSn dispersion layer 43 at the electrode pads 13 and 23 is higher than that at the Sn solder 42. As the AuSn dispersion layer 43 is generated, the AuSn compound layer, which is generated by the first melting and solidification, disappears. Therefore, an SnNi or CnSn compound is formed and bond strength of the solder fillet 41 is increased. Experiments show that when the AuSn dispersion layer 43 is equal to or more than about 50 μm in thickness, sufficient bond strength is given to the solder filet 41.

In one embodiment, when the solder ball 4 is melted twice as described above, the shrinkage distortion that is applied to the flexure 21 is relieved, and the flexure 21 is likely to return to its horizontal state before the solder bonding. Since the second melting and solidification are performed on the electrode pads 13 and 23, the Sn solder 42 slowly falls in temperature and is solidified after being melted (not rapid cooling). Therefore, the shrinkage distortion caused by the second solidification of the Sn solder 42 is not more than the shrinkage distortion caused by the first solidification thereof.

As shown in FIG. 8B, since the flexure 21 subjected to the solidification performed twice is less bent than the flexure 21 subjected to the solidification performed once (see FIG. 8B), such that a change in posture of the slider 11 is controlled and small.

The electrode pads 13 of the slider 11 and the electrode pads 23 of the flexible printed circuit 22 are bonded to each other by the solder fillet 41.

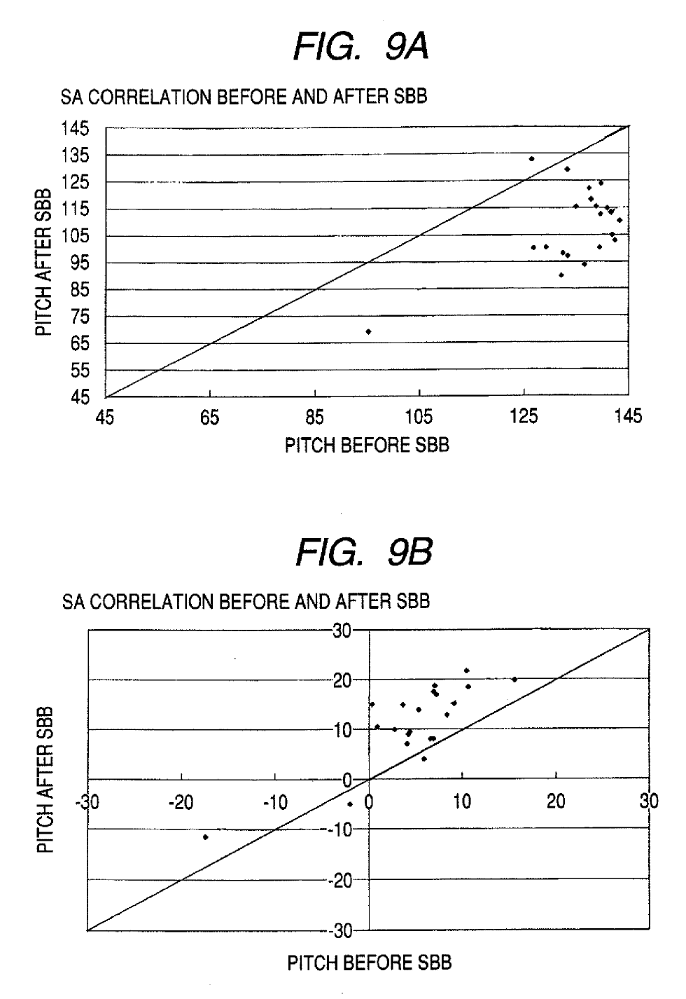

FIG. 9 is a scatter diagram that shows a change in posture (a change in pitch angle of the slider 11 before and after solder bonding. FIG. 9A shows a change in posture of the slider 11 in a case of the solder bonding by one laser irradiation (i.e., the solder ball 40 in a molten state free falls to the joint surface from the capillary 30). FIG. 9B shows a change in posture of the slider 11 in a case of the solder bonding by two laser irradiations (i.e., second laser irradiation is performed on the joint surface after the first laser irradiation). Measurement conditions for the change in posture of the slider are as follows.

Device: SBB (Solder Ball Bumper) manufactured by PacTech

Laser irradiation (first time): 40A for 2 ms

Laser irradiation (second time): 38A for 15 ms

Diameter of solder ball: 100 μm

As shown in FIGS. 9A and 9B, it is clear that a change in pitch angle before and after bonding is smaller in two laser irradiations than that in one laser irradiation. For example, an average value of changes in pitch angle after first laser irradiation is −68′, while and an average value of changes in pitch angle after the second laser irradiation is −26.5°. Therefore, the change of pitch angle after the second laser irradiation is regulated at half or less than the change of pitch angle after the first laser irradiation.

As the solder bonding method that forms the solder fillet 41 of FIG. 3, the embodiment in which the Sn solder 42 is melted and solidified by performing the two laser irradiations has been described. However, it is possible to form the solder fillet 41 without generating the AuSn compound layer on the surfaces of the electrode pads 13 and 23 by performing one laser irradiation.

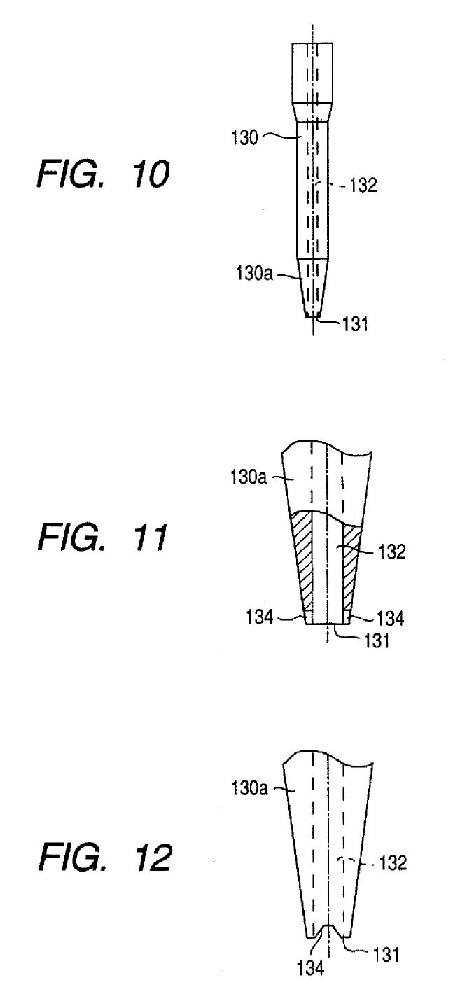

Hereinafter, a solder bonding method by performing one laser irradiation according to another embodiment of will be described with reference to FIGS. 10 to 18.

A capillary 130 shown in FIGS. 10 to 13 is prepared. The capillary 130 has a thin, long, and cylindrical shape and includes a delivery end portion 130a whose tip is narrow. The capillary 130 includes a circular delivery hole 131 that is formed at the center of a front end surface of the delivery end portion 130a so as to deliver a spherical solder ball 40. A carrier path 132 extends along an axial direction of the capillary 130 and carries the solder ball 40 and a nitrogen gas stream N₂. A plurality of notch portions 134 are formed at a front end wall (a delivery wall) at predetermined intervals in a circumferential direction. The plurality of notch portions 134 serve as both an opening for discharging a nitrogen gas stream N₂, which passes through the carrier path 132 and reaches the delivery hole 131, to the outside, and an opening for passing a laser beam irradiated from a different direction from a carrying direction of the solder ball 40. Each of the notch portions 134 is a trapezoid in section (See FIG. 12) where the notch portion 134 gets wider toward the front end of the delivery end portion 130a such that it is easy to directly irradiate a laser beam onto the solder ball 40.

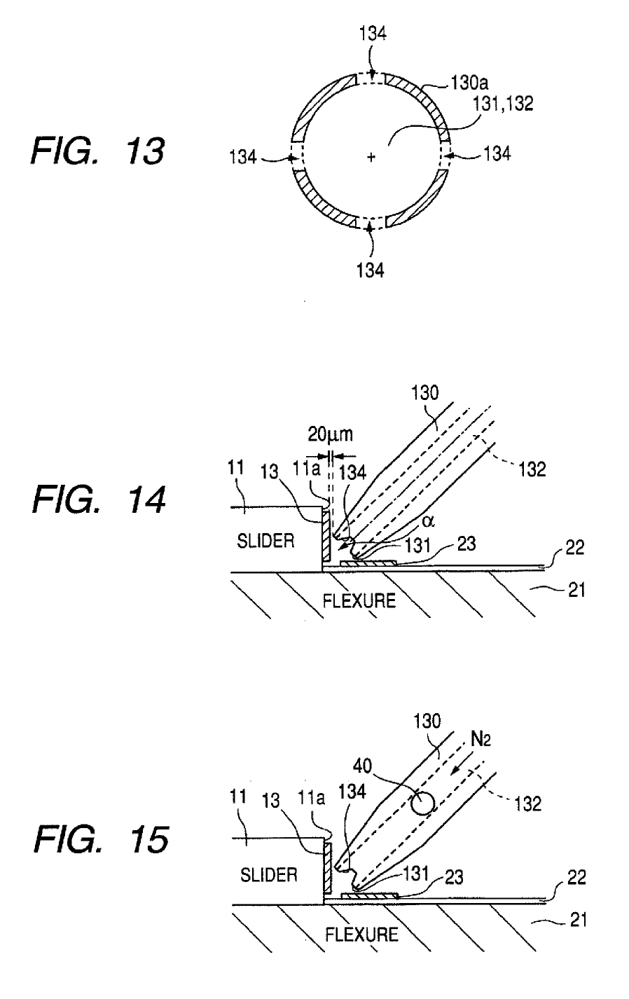

As shown in FIG. 13, the plurality of notch portions 134 are four notch portions obtained by cutting the front end wall of the delivery end portion 130a at 90-degree intervals, and emit a nitrogen gas stream N₂ in a crosswise direction from the delivery hole 131. Though not shown, the capillary 130 includes an induction hole through which the solder ball 40 and the nitrogen gas stream N₂ are inserted into the carrier path 132.

In one embodiment, the solder ball 40 is not more than about Ø100 μm in diameter, the delivery hole 131 and the carrier path 132 are more than the solder ball 40 in diameter. Depth of the notch portions 134 is less than that of the solder ball 40, an effective spot diameter of the laser beam used is in a range of about Ø50 to 100 μm.

As shown in FIG. 14, the capillary 130 is tilted about 45 degrees from both the electrode pads 13 of the slider 11 and the electrode pads 23 of the flexible printed circuit 22. The delivery end portion 130a of the capillary 30 is spaced about 20 μm from the joint surface of the electrode pads 13 of the slider 11 and the electrode pads 23 of the flexible printed circuit 22. Therefore, a space a for mounting and maintaining the solder ball 40 is formed between the electrode pads 13 of the slider 11, the electrode pads 23 of the flexible printed circuit 22, and the delivery end portion 130a (the delivery hole 131) of the capillary 130.

As shown in FIG. 15, the spherical solder ball 40 is inserted into the carrier path 132 of the capillary 130, and at the same time, the nitrogen gas stream N₂ is introduced into the carrier path 132 of the capillary 130. The solder ball 40, which is inserted into the carrier path 132 and is not melted, is sent to the delivery hole 131 by the nitrogen gas stream N₂ that flows within the same carrier path 132. The solder ball 40 in a state of not being melted free falls between the electrode pads 13 of the slider 11 and the electrode pads 23 of the flexible printed circuit 22 from the delivery hole 131. The solder ball 40 is formed of tin-based solder that does not include lead, and oxidization of the solder ball 40 is prevented by the nitrogen gas stream N₂.

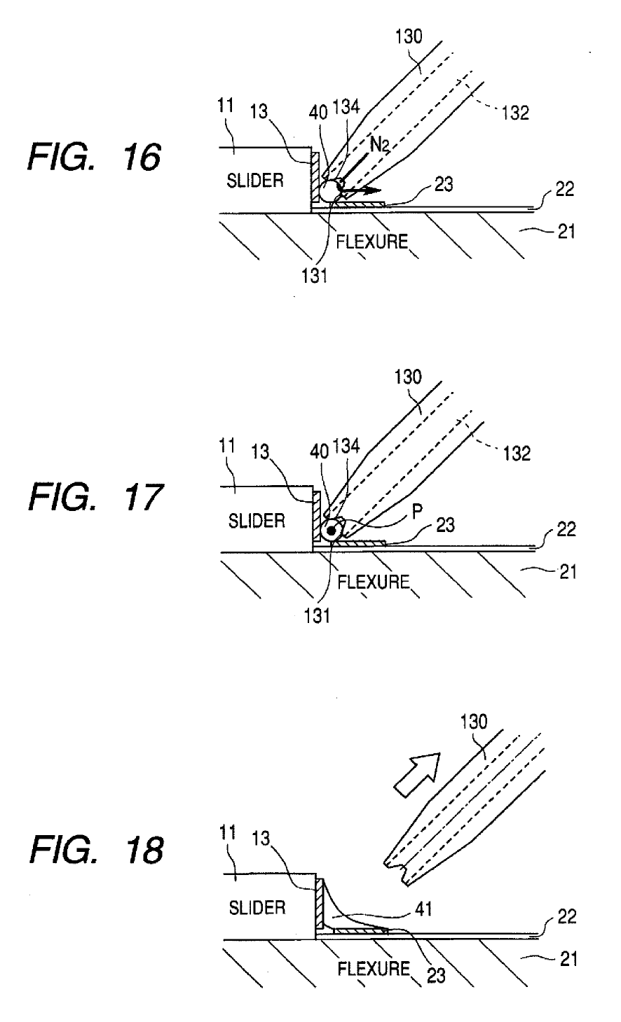

As shown in FIG. 16, position of the solder ball 40, which has free fallen, is determined and maintained on the joint surface of the electrode pads 13 of the slider 11 and the electrode pads 23 of the flexible printed circuit 22 by the nitrogen gas stream N₂ that is radially emitted from the plurality of notch portions 134 formed at the front end wall of the delivery end portion 130a. In one embodiment, it is ideal that the solder ball 40 free falls right under the central position of the delivery hole 131 from the delivery hole 131. The solder ball 40 may be separated from the central position of the deliver hole 131. In the present embodiment, since four notch portions 134 are formed at about 90 degree intervals in the circumferential direction of the front end wall of the delivery end portion 130a, if the solder ball 40 is separated from the central position of the delivery hole 131, the nitrogen gas stream N₂ becomes as narrow as the separation of the solder ball 40, and the solder ball 40 returns to the center by a repulsive force applied from the nitrogen gas stream N₂. Therefore, the solder ball 40 is always maintained at the central position of the delivery hole 131.

As shown in FIG. 17, the solder ball 40 is maintained by the nitrogen gas stream N₂ and the delivery hole 131, a laser beam passes through the plurality of notch portions of the capillary 130 and is directly irradiated onto the solder ball 40. In FIG. 17, reference mark 2 denotes a laser irradiation position. The laser irradiation is performed by a separate laser heat source from the capillary 130 in a direction different from the direction in which the delivery hole 131 of the capillary 130 faces (i.e., the direction in which the solder ball 40 is carried by the nitrogen gas stream N₂).

For example, like the capillary 30, in a state where the capillary 130 is tilted about 45 degrees from both sides of the electrode pads 13 of the slider 11 and the electrode pads 23 of the flexible printed circuit 22, the laser beam is irradiated from a direction in which the capillary 30 is rotated clockwise or counterclockwise at a predetermined angle. At this time, since power of the laser beam completely melts the solder ball 40, the power is set such that an effective spot diameter of the laser beam is slightly smaller than the solder ball 40.

In one embodiment, since the solder ball 40 having a diameter of about 100 μm is used, it is preferable that the effective spot diameter of the laser beam be about 50 μm. As a laser heat source, a semiconductor laser that emits a laser beam of low energy or an ultraviolet laser may be used. Since the plurality of notch portions 134 are formed in a trapezoid section where each of the notch portions 134 gets wider toward the front end of the delivery end portion 130a so as to easily pass the laser beam, loss of laser beam is low. Therefore, it is possible to effectively apply the laser beam to the solder ball 40.

As shown in FIG. 18, when the laser irradiation starts, the capillary 130 is made separate from the joint surface of the electrode pads 13 of the slider 11 and the electrode pads 23 of the flexible printed circuit 22, and the laser irradiation continues for a predetermined time so as to completely melt the solder ball 40. By the solder fillet 41 that is solidified again after being completely melted, the electrode pads 13 of the slider 11 and the electrode pads 23 of the flexible printed circuit 22 are bonded to each other.

According to another embodiment, even though the laser irradiation is performed once, the solder ball 40 is completely melted on the joint surface. Therefore, at the solder fillet 41, the AuSn dispersion layer 43 in which Au plating layers 13a and 23a on the surfaces of the electrode pads 13 and 23 are dispersed within the molten solder is formed at least along the boundary of the electrode pads 13 and 23. For example, since an AuSn compound layer is not formed but a SnNi or CuSn compound is formed, sufficient bond strength can be applied to the solder fillet 41. In addition, since the solder melted by the laser irradiation does not rapidly cool down, shrinkage distortion caused by solidification of the solder can be reduced. Therefore, it is possible to appropriately prevent a change in posture of the slider 11.

In present exemplary embodiments, the nitrogen gas stream N₂ is used when carrying the solder ball 40. However, in addition to the nitrogen gas stream N₂, inert gas streams, such as He, Ne, Ar or the like, may be used. In addition, the Sn solder that does not include lead is used as the solder ball, but lead-based solder or tin-based solder may be used.

In at least one embodiment, it is possible to achieve the magnetic head assembly and the solder bonding method thereof that are capable of increasing bond reliability and a change in posture of the slider.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A magnetic head assembly that bonds electrode pads of a slider having a magnetoresistive element installed therein and electrode pads of a flexible printed circuit connecting the magnetoresistive element to an external circuit by solder, the magnetic head assembly comprising:
an Au layer that is formed on solder contact surfaces of the electrode pads of the slider and the flexible printed circuit, and
an AuSn dispersion layer where Au atoms of the Au layer are dispersed and that is formed at least on the boundary between the solder contact surfaces of the electrode pads and the solder.

2. The magnetic head assembly according to claim 1,
wherein the AuSn dispersion layer is equal to or greater than about 50 μm in thickness.

3. The magnetic head assembly according to claim 1,
wherein the AuSn dispersion layer has a Au atomic content that increases toward the electrode pads from the solder.

4. The magnetic head assembly according to claim 1,
wherein an Sn compound layer that is made of materials of the electrode pads and Sn is interposed between the electrode pads and the AuSn dispersion layer.

5. The magnetic head assembly according to claim 4,
wherein the electrode pad has a single layer structure of Ni or Cu, or a laminated structure of Ni and Cu.

6. A solder bonding method of a magnetic head assembly that bonds electrode pads of a slider having a magnetoresistive element installed therein and electrode pads of a flexible printed circuit connecting the magnetoresistive element and an external circuit by solder, the method comprising:
preparing a capillary that has a carrier path that carries a solder ball by an inert gas stream and melts the solder ball by a laser beam passing through the carrier path;
disposing the capillary on bonding surfaces between the electrode pads of the slider and the electrode pads of the flexible printed circuit;
introducing the solder ball and an inert gas stream into the carrier path of the capillary and causing the solder ball to drop on the bonding surfaces of the electrode pads with the solder ball melted by the laser beam passing through the same carrier path;
waiting until the solder ball is solidified; and
remelting the solidified solder ball by laser beam irradiation to resolidify the remelted solder ball and bonding the electrode pads of the slider to the electrode pads of the flexible printed circuit.

7. The solder bonding method of a magnetic head assembly according to claim 6,
wherein in the irradiation of the laser beam onto the solidified solder ball, the capillary is approached to the solder ball, and the solder ball is remelted ball by the laser beam that passes through the carrier path of the capillary.

8. The solder bonding method of a magnetic head assembly according to claim 6,
wherein in the irradiation of the laser beam onto the solidified solder ball, the solder ball is remelted by a laser beam irradiated from a direction different from the capillary.

9. The solder bonding method of a magnetic head assembly according to claim 6,
wherein the laser beam is irradiated by using a semiconductor laser, an ultraviolet laser, or a YAG laser.
